(19) United States
(12) Patent Application Publication
(10) Pub. No.: US 2026/0204620 A1
(43) Pub. Date: Jul. 16, 2026

(54) NONAQUEOUS ELECTROLYTE SECONDARY BATTERY

(71) Applicant: Panasonic Energy Co., Ltd., Moriguchi-shi, Osaka (JP)

(72) Inventors: Takayuki Nakatsutsumi, Osaka Fu (JP); Hirohito Umeno, Osaka Fu (JP); Tomohiro Harada, Osaka Fu (JP)

(73) Assignee: Panasonic Energy Co., Ltd., Moriguchi-shi, Osaka (JP)

(21) Appl. No.: 19/132,170

(22) PCT Filed: Nov. 9, 2023
(86) PCT No.: PCT/JP2023/040426

§ 371 Date: May 22, 2025

(30) Foreign Application Priority Data
Nov. 28, 2022 (JP) 2022-189188

(51) Int. Cl. H01M 10/0525; H01M 4/02; H01M 4/525; H01M 4/583; H01M 10/0568; H01M 10/0569

(52) U.S. Cl. CPC H01M 10/0525; H01M 4/525; H01M 4/583; H01M 10/0568; H01M 10/0569; H01M 2004/021; H01M 2004/027; H01M 2004/028; H01M 2300/0037

(57) ABSTRACT

A nonaqueous electrolyte secondary battery includes a positive electrode, a negative electrode, and a nonaqueous electrolyte. The negative electrode includes a silicon-containing carbon material. The silicon-containing carbon material includes an amorphous carbon phase, and silicon phases dispersed in the amorphous carbon phase. The nonaqueous electrolyte contains a nonaqueous solvent, and a salt dissolved in the nonaqueous solvent. The nonaqueous solvent contains fluoroethylene carbonate and a fluorine-containing carboxylic acid ester.

### TECHNICAL FIELD

The present disclosure relates to a nonaqueous electrolyte secondary battery.

### BACKGROUND ART

Patent Literature 1 proposes “a nonaqueous electrolyte secondary battery, comprising a positive electrode, a negative electrode, and a nonaqueous electrolyte containing a solvent and a solute, wherein the nonaqueous electrolyte contains a fluorinated compound represented by R1-C═O—OR2 where R1 is a fluorinated alkyl group or an alkoxy group, and R2 is a methyl group, and a chain carboxylic acid ester, and a content ratio of the fluorinated compound in the solvent is in the range of 5 to 30 vol %.”

### CITATION LIST

### Patent Literature

Patent Literature 1: Japanese Laid-Open Patent Publication No. 2014-67490

### SUMMARY OF INVENTION

### Technical Problem

By using a silicon-containing material as a negative electrode active material, a battery with high capacity-density can be realized. The silicon-containing material, however, expands and contracts considerably in association with charging and discharging, and a surface film (solid electrolyte interface: SED derived from the nonaqueous electrolyte, which is formed on the surface of the silicon-containing material, is continuously destroyed with the expansion and contraction of the silicon-containing material. In the region where the SEI is destroyed, the nonaqueous electrolyte will be decomposed again, to form a SEI. As a result of repetition of such formation and destruction of a surface film, the internal resistance of the battery increases gradually. For increasing the capacity, however, a higher content ratio of the silicon phases in the silicon-containing material is more advantageous.

### Solution to Problem

One aspect of the present disclosure relates to a nonaqueous electrolyte secondary battery, including a positive electrode, a negative electrode, and a nonaqueous electrolyte, wherein the negative electrode includes a silicon-containing carbon material, the silicon-containing carbon material includes an amorphous carbon phase, and silicon phases dispersed in the amorphous carbon phase, the nonaqueous electrolyte contains a nonaqueous solvent, and a salt dissolved in the nonaqueous solvent, and the nonaqueous solvent contains fluoroethylene carbonate and a fluorine-containing carboxylic acid ester.

### Advantageous Effects of Invention

According to the present disclosure, despite the inclusion of a silicon-containing carbon material as a silicon-containing material in the negative electrode, it is possible to suppress the increase in internal resistance.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A longitudinal sectional view of a secondary battery according to one embodiment of the present disclosure.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components for secondary batteries may be adopted. In the present specification, when referring to “a range of a numerical value A to a numerical value B,” the range includes the numerical value A and the numerical value B. For example, “A to B mol %” is equivalent to “A mol % or more and B mol % or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

The nonaqueous electrolyte secondary battery includes a lithium-ion secondary battery in which at least a material that reversibly absorbs and releases lithium ions is used as a negative electrode active material, a solid-state battery including a gel electrolyte, and the like.

In the present specification, the “internal resistance” means a direct current resistance (DCIR) value. According to the present disclosure, the increase rate of DCIR when, for example, a charge-discharge cycle of the nonaqueous electrolyte secondary battery is repeated in a 25° C. environment can be suppressed low.

The nonaqueous electrolyte secondary battery according to the present disclosure includes a positive electrode, a negative electrode, and a nonaqueous electrolyte. A separator is usually disposed between the positive electrode and the negative electrode. The nonaqueous electrolyte usually has lithium-ion conductivity.

The negative electrode includes a silicon-containing carbon material as a negative electrode active material. The silicon-containing carbon material is a material that contains an amorphous carbon phase and silicon phases dispersed in the amorphous carbon phase.

Such a silicon-containing carbon material is hereinafter sometimes referred to as a “Si/AmoC”. Since the negative electrode active material contains silicon phases, the nonaqueous electrolyte secondary battery can achieve high capacity. The more the silicon phases are contained, the more advantageous it is for achieving high capacity. Besides, the nonaqueous electrolyte contains fluoroethylene carbonate (hereinafter sometimes referred to as “FEC”) and a fluorine-containing carboxylic acid ester (hereinafter sometimes referred to as a “carboxylic acid ester (F)”).

Despite being a silicon-containing material, when the Si/AmoC is used in combination with FEC and a carboxylic acid ester (F), the increase rate of DCIR during repeated charge-discharge cycles of the nonaqueous electrolyte secondary battery can be suppressed low. This effect is presumably resulted from the FEC and the carboxylic acid ester (F) forming a hybrid surface film (SEI) that is unlikely to be destroyed on the surface of the Si/AmoC. In such an SEI, LiF is much contained. When the nonaqueous electrolyte further contains a cyclic acid anhydride, the effect of suppressing the increase in DCIR during repeated charge-discharge cycles is further increased.

On the other hand, in the case of using, as a negative electrode material, a silicon-containing material, such as a material containing a SiO₂ phase and silicon phases dispersed in the SiO₂ phase (hereinafter sometimes referred to as a “SiCₓ”), metal Si, and Si alloy, when a carboxylic acid ester (F) is used, on the contrary, the increase rate of DCIR increases. This is presumably because of the generation of hydrofluoric acid (HF) by the decomposition of the carboxylic acid ester (F), which causes the SiOx, metal Si, Si alloy, or the like to deteriorate.

The amorphous carbon does not reaction with HF and the silicon phases dispersed in the amorphous carbon phase are covered with the amorphous carbon. Therefore, among silicon-containing materials, when a Si/AmoC is used, the effect of suppressing the increase in DCIR by the carboxylic acid ester (F) becomes specifically apparent.

The specificity of the Si/AmoC as described above makes possible the increase of the amount of silicon phases dispersed in the amorphous carbon phase and makes possible the increase of the mass ratio of the Si/AmoC in the negative electrode active material. In other words, since the deterioration of the Si/AmoC is suppressed, even when used in a large amount, there is little concern about the increase of the decomposition reaction of the nonaqueous electrolyte due to the expansion and contraction of the silicon phases.

It is desirable to control the average size of the silicon phases dispersed in the amorphous carbon phase to a small size. The larger the size of the silicon phases is, the more likely the amorphous carbon phase is to have cracks due to the expansion and contraction of the silicon phase. In that case, HF can enter through the cracks, causing a reaction between HF and the silicon phases. In other words, the smaller the size of the silicon phases is, and the less likely the amorphous carbon phase is to have cracks, the higher the effect of blocking HF becomes, and the more likely the amorphous carbon phase is to demonstrate its defensibility against HF.

The components of the nonaqueous electrolyte secondary battery according to the present disclosure will be described in more detail below.

### [Negative Electrode]

The negative electrode includes a negative electrode active material. The negative electrode usually includes a negative electrode current collector, and a layer of a negative electrode mixture (hereinafter, a “negative electrode mixture layer”) held on the negative electrode current collector. The negative electrode mixture layer can be formed by applying a negative electrode slurry in which constituent components of the negative electrode mixture are dispersed in a dispersion medium, onto a surface of the negative electrode current collector, followed by drying. The applied film after drying may be rolled as necessary. The dispersion medium used for the negative electrode slurry includes, but is not limited to, for example, water, an alcohol, N-methyl-2-pyrrolidone (NMP), and a mixed solvent thereof.

The negative electrode mixture contains a negative electrode active material as an essential component, and can contain a binder, a thickener, a conductive agent, and the like as optional components.

### (Negative Electrode Active Material)

The negative electrode active material includes at least a Si-containing carbon material (Si/AmoC). The Si-containing carbon material, in the state where lithium ions are absorbed therein, may contain fine lithium alloy. The negative electrode active material may further include another material capable of electrochemically absorbing and releasing lithium ions. An example of such a material is a carbonaceous material.

When excellent cycle characteristics and high capacity are to be obtained in a balanced manner, using a Si/AmoC in combination with a carbonaceous material is desirable. The mass ratio of the Si/AmoC in the negative electrode active material can be set higher than that of the SiOₓ, for example. The ratio of the Si/AmoC in the total of the Si/AmoC and the carbonaceous material is, for example, 5 mass % or more, may be 7 mass % or more, and may be 10 mass % or more, or 15 mass % or more. When more importance is placed on the improvement in cycle characteristics, the ratio of the Si AmoC in the total of the Si/AmoC and the carbonaceous material is, for example, 50 mass % or less, may be 40 mass % or less, may be 30 mass % or less, and may be 20 mass % or less. The ratio of the Si/AmoC in the total of the Si/AmoC and the carbonaceous material is, for example, 5 mass % or more and 50 mass % or less, may be 7 mass % or more and 40 mass % or less, may be 10 mass % or more and 30 mass % or less, and may be 15 mass % or more and 20 mass % or less.

<<Carbonaceous Material>>

Examples of the carbonaceous material include graphite, graphitizable carbon (soft carbon), and non-graphitizable carbon (hard carbon). The carbonaceous material may be used singly, or in combination of two or more kinds. In particular, as the carbonaceous material, a crystalline carbon is preferred because of its excellent stability during charging and discharging and its low irreversible capacity. Examples of the crystalline carbon include natural graphite, artificial graphite, and graphitized mesophase carbon particles. Crystalline carbon, in general, refers to a carbonaceous material having an average interplanar spacing d₀₀₂ of the (002) plane measured by X-ray diffractometry of 0.340 nm or less (e.g., 0.3354 nm or more and 0.340 nm or less).

### <<Si/AmoC>>

The Si/AmoC includes an amorphous carbon phase, and silicon phases or silicon particles dispersed in the amorphous carbon phase. Amorphous carbon, in general, refers to a carbon material having an average interplanar spacing d₀₀₂ of the (002) plane measured by X-ray diffractometry of more than 0.34 nm. The amorphous carbon phase has lithium-ion conductivity. Therefore, lithium ions can move between the silicon phases and the nonaqueous electrolyte. The amorphous carbon constituting the amorphous carbon phase may be, for example, hard carbon, soft carbon, or others.

An amorphous carbon can be obtained by, for example, sintering a carbon source in an inert atmosphere, and pulverizing the obtained sintered body. The Si/AmoC can be obtained by, for example, mixing a carbon source with Si particles, stirring the mixture while crushing the mixture in a stirrer, such as a ball mill, and then, baking the mixture in an inert atmosphere. The carbon source that can be used includes, for example, commercially available graphitizable carbon (soft carbon), carboxymethyl cellulose (CMC), polyvinylpyrrolidone, cellulose, saccharides such as sucrose, and water-soluble resins. In mixing a carbon source with Si particles, for example, the carbon source and the Si particles may be dispersed in a dispersion medium, such as an alcohol. Alternatively, the Si/AmoC may be formed by a CVD method, by allowing a silicon source and a carbon source to react in a gas phase.

The content ratio of the silicon phases in the Si/AmoC can be set high, as compared to in the SiOₓ, for example. The content ratio of the silicon phases in the Si/AmoC is, for example, 40 mass % or more, may be 50 mass % or more, and may be 55 mass % or more. In view of minimizing the influence of the expansion and contraction of the silicon phases, the content ratio of the silicon phases in the Si/AmoC is, for example, 80 mass % or less, may be 70 mass % or less, and may be 65 mass % or less. Within the range as above, a sufficiently high capacity of the negative electrode can be achieved, and the cycle characteristics can also be easily improved. The content ratio of the silicon phases in the Si/AmoC is, for example, 40 mass % or more and 80 mass % or less, may be 50 mass % or more and 70 mass % or less, and may be 55 mass % or more and 65 mass % or less.

The content ratio of the silicon phases in the Si/AmoC can be measured by inductively coupled plasma (ICP) emission spectroscopy. In the Si/AmoC, Si, C, and O are contained as major elements. Presumably, Si is contained as metal Si or SiO₂, C is contained as C, and O is contained as SiO₂. Therefore, given that the amounts of Si, C, and O detected by ICP are “a” (mol), “b” (mol), and “c” (mol), respectively, the amount x of the metal Si by mol can be x=a−c/2. From the above values of x, a, b, and c, the content ratio of the silicon phases in the Si/AmoC can be determined.

The average particle diameter of the Si/AmoC is desirably 1 μm or more, and may be 2 μm or more, for ensuring sufficient reactivity between the silicon phases and lithium ions. The average particle diameter of the Si/AmoC is desirably 18 μm or less, and may be 15 μm or less, for reducing the influence of expansion and contraction of the silicon phases.

The average particle diameter of the Si/AmoC may be 1 μm or more and 18 μm or less, and may be 2 μm or more and 15 μm or less.

The average particle diameter of the Si/AmoC means a particle diameter at 50% cumulative volume (volume average particle diameter) in a particle size distribution measured by a laser diffraction and scattering method. As the measuring instrument, for example, “LA-750”, available from Horiba, Ltd. (HORIBA) can be used.

The average particle diameter of the Si/Amo-C may be measured, using the negative electrode taken out from a disassembled nonaqueous electrolyte secondary, by observing a cross section of the negative electrode mixture layer with a SEM or TEM. In this case, the average particle diameter can be determined by arithmetically averaging the maximum diameters of 100 randomly selected particles.

The Si/AmoC can be taken out from the battery in the following manner. First, a battery in a fully discharged state is disassembled to take out the negative electrode, which is then washed with anhydrous ethyl methyl carbonate or dimethyl carbonate, to remove the nonaqueous electrolyte components. The negative electrode includes a negative electrode current collector and a negative electrode mixture layer supported on its surface. The negative electrode mixture layer is peeled off from the negative electrode current collector and ground in a mortar, to obtain a sample powder. Next, the sample powder is dried in a dry atmosphere for 1 hour, and immersed in weakly boiled 6M hydrochloric acid for 10 minutes, to remove elements derived from components, such as a binder, other than Si/AmoC. Next, the sample powder is washed with ion-exchanged water, and filtered, followed by drying at 200° C. for 1 hour, and thus, a carbonaceous material and a Si/AmoC can be isolated. The fully discharged state means a state in which the depth of discharge (DOD) is 90% or more (the state of charge (SOC) is 10% or less). The carbonaceous material and the Si/AmoC can be separated from each other by sieving or centrifugation.

### <<Silicon Phases>>

The silicon phases are phases of elementary silicon (Si), and repeatedly absorb and release lithium ions thereinto and therefrom in association with charging and discharging of the battery. The capacity develops through the Faradaic reaction in which the silicon phases are involved.

The silicon phases are usually, in a particulate state, dispersed in the amorphous carbon phase. Since the silicon phases have a large capacity, and expands and contracts to great extent in association with charging and discharging, it is desirable that the particulate silicon phases have a small average size. The average particle diameter of the silicon phases is desirably, for example, 20 nm or less, may be less than 20 nm, and may be 15 nm or less. By making the silicon phases finer as above, the volume changes of the Si/AmoC during charging and discharging are reduced, the occurrence of cracks in the amorphous carbon phase is reduced, and the defensibility of the amorphous carbon against HF can be improved.

The average particle diameter of the silicon phases can be measured using a cross-sectional image of the Si/AmoC obtained with a transmission electron microscope (TEM). Specifically, the average particle diameter of the silicon phases can be determined by arithmetically averaging the maximum diameters of 100 randomly selected silicon phases.

The silicon phases can be each constituted of a plurality of crystallites. The crystallite size of the silicon phases is very small, which is preferably 50 nm or less. When the crystallite size of the silicon phases is small as above, the volume changes of the silicon phases associated with expansion and contraction during charging and discharging can be further reduced. The lower limit value of the crystallite size of the silicon phases is not particularly limited, and is, for example, 1 nm or more. The crystallite size of the silicon phases is calculated from the Scherrer's equation, using the half-value width of a diffraction peak belonging to the (111) plane of the silicon phase (elementary Si) in an X-ray diffraction pattern.

### (Negative Electrode Binder)

As the negative electrode binder, for example, a resin material can used. Examples of the binder include fluorocarbon resins, polyolefin resins, polyamide resins, polyimide resins, acrylic resins, vinyl resins, and rubbery materials (e.g., styrene-butadiene copolymer (SBR)). The binder may be used singly or in combination of two or more kinds.

### (Thickener)

As the thickener, for example, a cellulose derivative, such as cellulose ether, can be used. Examples of the cellulose derivative include carboxymethyl cellulose (CMC) and modified products thereof, and methyl cellulose. The thickener may be singly or in combination of two or more kinds.

### (Negative Electrode Conductive Material)

Examples of the negative electrode conductive material include carbon nanotubes (CNTs), carbon fibers other than CNTs, and conductive particles (e.g., carbon black, graphite).

### (Negative Electrode Current Collector)

As the negative electrode current collector, for example, a metal foil can be used. The negative electrode current collector may be porous. Examples of the material of the negative electrode current collector include stainless steel, nickel, nickel alloy, copper, and copper alloy. The thickness of the negative electrode current collector is not particularly limited, and is, for example, 1 to 50 μm, and may be 5 to 30 μm.

### [Positive Electrode]

The positive electrode includes a positive electrode active material. The positive electrode, usually, includes a positive electrode current collector and a layer of a positive electrode mixture (hereinafter, a “positive electrode mixture layer”) held on the positive electrode current collector. The positive electrode mixture layer can be formed by applying a positive electrode slurry in which constituent components of the positive electrode mixture are dispersed in a dispersion medium, onto a surface of the positive electrode current collector, followed by drying. The applied film after drying may be rolled as necessary. The positive electrode mixture contains a positive electrode active material as an essential component, and may contain a binder, a thickener, and the like as optional components. The dispersion medium used in the positive electrode slurry includes, but is not limited to, for example, water, an alcohol, NMP, and a mixed solvent thereof.

### (Positive Electrode Active Material)

The positive electrode active material may be any material that can be used as a positive electrode active material for a nonaqueous electrolyte secondary battery (e.g., a lithium-ion secondary battery), but in view of achieving high capacity, desirably includes a lithium-transition metal composite oxide (hereinafter sometimes referred to as a “composite oxide N”) containing at least nickel as a transition metal. The ratio of the composite oxide N in the positive electrode active material is, for example, 70 mass % or more, 90 mass % or more, or 95 mass % or more.

In view of ensuring high capacity, the ratio of Ni to the metals other than lithium contained in the composite oxide N may be 80 atom % or more, may be 90 atom % or more, and may be 95 atom % or more. In view of the structural stability, the ratio of Ni to the metals other than lithium contained in the composite oxide N may be 99 atom % or less, may be 98 atom % or less, and may be 97 atom % or less.

The composite oxide N may be, for example, a lithium-transition metal composite oxide having a layered rock-salt type structure, and containing Ni and at least one selected from the group consisting of Co, Mn, and Al. Hereinafter, a lithium-transition metal composite oxide having a layered rock-salt type structure, and containing Ni and at least one selected from the group consisting of Co, Mn, and Al in which the ratio of Ni to the metal elements other than Li is 80 atom % or more is sometimes referred to as a “composite oxide HN”. The ratio of the composite oxide IN in the composite oxide N used as the positive electrode active material is, for example, 90 mass % or more, may be 95 mass % or more, and may be 100%.

The higher the ratio of Ni is, the more the lithium ions can be extracted from the composite oxide HN during charging, leading to increased capacity. However, Ni in the composite oxide HN with increased capacity has a tendency to have a higher valence. Also, when the ratio of Ni is increased, the ratios of other elements become relatively small. In this case, the crystal structure tends to become unstable, and side reactions tend to occur with repeated charging and discharging. On the particle surfaces of the composite oxide HN having a high Ni content, Ni is apt to change to have a crystal structure that is difficult to reversibly absorb and release lithium ions.

In the nonaqueous secondary battery according to the present disclosure, despite the use of the composite oxide HN having such a high Ni content in the positive electrode and the use of the silicon-containing material (Si/AmoC) in the negative electrode, the increase in DCIR can be suppressed by using FEC and a carboxylic acid ester (F) in combination.

Co, Mn, and Al contribute to stabilizing the crystal structure of the composite oxide HN having a high Ni content. However, in view of reducing manufacturing costs, a smaller Co content is more desirable. A composite oxide HN having a small Co content (or containing no Co) may contain Mn and Al.

The composite oxide HN is represented by, for example, a formula: Li_{α}Ni_{(1-x1-x2-y-z)}Coₓ₁Mnₓ₂Al_{y}M_{z}O_{2+β}. The element M is an element other than Li, Ni, Co. Mn, Al, and oxygen.

In the above formula, the α representing the atomic ratio of lithium is, for example, 0.95≤α≤1.05. The α increases and decreases during charging and discharging. In the (2+β) representing the atomic ratio of oxygen, β satisfies −0.05≤β≤0.05.

The 1-x1-x2-y-z (=v) representing the atomic ratio of Ni is, for example, 0.8 or more, may be 0.85 or more, may be 0.90 or more, or 0.95 or more. The v representing the atomic ratio of Ni may be 0.98 or less, and may be 0.95 or less. When defining a range, these upper and lower limits can be combined in any combination.

The x1 representing the atomic ratio of Co is, for example, 0.1 or less (0≤x1≤0.1), may be 0.08 or less, may be 0.05 or less, and may be 0.01 or less. When x1 is 0, this encompasses a cases where Co is below the detection limit.

The x2 representing the atomic ratio of Mn is, for example, 0.1 or less (0≤x2≤0.1), may be 0.08 or less, may be 0.05 or less, and may be 0.03 or less. The x2 may be 0.01 or more, and may be 0.03 or more. Mn contributes to stabilizing the crystal structure of the composite oxide HN. Also, containing Mn, which is inexpensive, in the composite oxide HN is advantageous for cost reduction. When defining a range, these upper and lower limits can be combined in any combination.

The y representing the atomic ratio of Al is, for example, 0.1 or less (0≤y≤0.1), may be 0.08 or less, may be 0.05 or less, and may be 0.03 or less. The y may be 0.01 or more, and may be 0.03 or more. Al contributes to stabilizing the crystal structure of the composite oxide HN. When defining a range, these upper and lower limits can be combined in any combination.

The z representing the atomic ratio of the element M is, for example, 0≤z≤0.10, may be 0<z≤0.05, and may be 0.001≤z≤0.01.

The element M may be at least one selected from the group consisting of Ti, Zr, Nb, Mo, W, Fe, Zn, B, Si, Mg, Ca, Sr, Sc, and Y. In particular, when at least one selected from the group consisting of Nb, Sr, and Ca is contained in the composite oxide HN, the surface structure of the composite oxide HN is stabilized, the resistance is reduced, and the leaching of the metal can be further suppressed. It is more effective when the element M is localized near the particle surfaces of the composite oxide HN.

The content ratios of the elements constituting the composite oxide N can be measured using an inductively coupled plasma atomic emission spectroscopy (ICP-AES), an electron probe microanalyzer (EPMA), an energy dispersive X-ray spectroscopy (EDX), or the like.

The composite oxide N is, for example, secondary particles each formed of an aggregate of primary particles. The particle diameter of the primary particles is, for example, 0.05 μm or more and 1 μm or less. The average particle diameter of the secondary particles of the composite oxide N is, for example, 3 μm or more and 30 μm or less, and may be 5 μm or more and 25 μm or less.

In the present specification, the average particle diameter of the secondary particles means a particle diameter at 50% cumulative volume (volume average particle diameter) in a particle size distribution measured by a laser diffraction and scattering method. Such a particle diameter is sometimes referred to as D50. As the measuring instrument, for example, “LA-750”, available from Horiba, Ltd. (HORIBA) can be used.

### (Positive Electrode Binder)

As the positive electrode binder, for example, a resin material can used. Examples of the binder include fluorocarbon resins, polyolefin resins, polyamide resins, polyimide resins, acrylic resins, and vinyl resins. The binder may be used singly or in combination of two or more kinds.

### (Positive Electrode Conductive Material)

Examples of the positive electrode conductive material include carbon nanotubes (CNTs), carbon fibers other than CNTs, and conductive particles (e.g., carbon black, graphite).

### (Positive Electrode Current Collector)

As the positive electrode current collector, for example, a metal foil can be used. The positive electrode current collector may be porous. The porous current collector may be, for example, a net, a punched sheet, an expanded metal, and the like. Examples of the material of the positive electrode current collector include stainless steel, aluminum, aluminum alloy, and titanium. The thickness of the positive electrode current collector is not particularly limited, and is, for example, 1 to 50 μm, and may be 5 to 30 tin.

### [Nonaqueous Electrolyte]

The nonaqueous electrolyte contains a nonaqueous solvent and a salt (electrolyte salt). The nonaqueous solvent contains at least fluoroethylene carbonate (FEC) and a fluorine-containing carboxylic acid ester (carboxylic acid ester (F)). The FEC and the carboxylic acid ester (F) form a hybrid surface film (SEI) with good quality on the surface of the silicon-containing material. In a carbonic acid ester and a carboxylic acid ester with fluorine atoms introduced therein, the electron density is lowered as a result of introducing fluorine atoms, which have strong electron-withdrawing property, thereinto as a substituent. Such acid esters, therefore, are less likely to be oxidized at the positive electrode. Thus, side reactions are suppressed at both the positive and negative electrodes.

The nonaqueous electrolyte containing a nonaqueous solvent is usually an electrolyte solution in a liquid state, and may have limited fluidity with a gelling agent or the like. In the case of a lithium-ion secondary battery, a lithium salt is used as the salt.

### (FEC)

FEC is an excellent SEI forming material, and especially when FEC is used in combination with a carboxylic acid ester (F), a more stable SEI is formed. On the other hand, when the nonaqueous electrolyte contains no FEC and contains only a carboxylic acid ester (F) as an additive, the strength of the SEI becomes insufficient.

The content ratio of the FEC in the nonaqueous solvent is, for example, 5 vol % or more, may be 10 vol % or more, or may be 15 vol % or more. The content ratio of the fluoroethylene carbonate in the nonaqueous solvent is, for example, 30 vol % or less, may be 25 vol % or less. The range of the content ratio of the FEC in the nonaqueous solvent is, for example, 5 vol % to 30 vol %, and may be 10 vol % to 25 vol %.

### (Carboxylic Acid Ester (F))

As the fluorinated carboxylic acid ester, an alkyl ester of carboxylic acid with fluorine atoms introduced therein, a fluorinated alkyl ester of carboxylic acid without fluorine atoms introduced therein, and a fluorinated alkyl ester of carboxylic acid with fluorine atoms introduced therein, and the like are exemplified. Specific examples thereof include: a trifluoropropionic acid ester (hereinafter sometimes referred to as a trifluoropropionic acid ester (1)) represented by a formula (1):

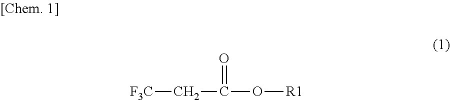

where R1 is a C₁₋₃ alkyl group; a fluorinated carboxylic acid ester (hereinafter sometimes referred to as a fluorinated carboxylic acid ester (2)) represented by a formula (2):

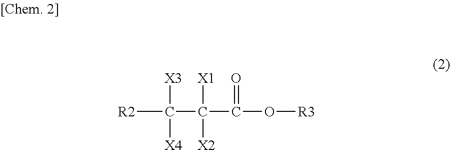

where X1, X2, X3, and X4 are independently a hydrogen atom or a fluorine atom, one or two of X1 to X4 are a fluorine atom, R2 is a hydrogen atom, a C₁₋₃ alkyl group, or a fluorinated C₁₋₃ alkyl group, and R3 is a C₁₋₃ alkyl group or a fluorinated C₁₋₃ alkyl group; and a carboxylic acid-fluoroalkyl ester (hereinafter sometimes referred to as a carboxylic acid-fluoroalkyl ester (3)) represented by a formula (3):

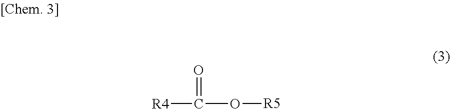

wherein R4 is a C₁₋₃ alkyl group, and R5 is a fluorinated C₁₋₃ alkyl group.

In the formula (1), examples of the C₁₋₃ alkyl group represented by R1 include methyl, ethyl, n-propyl, and i-propyl groups. In particular, preferred are methyl and ethyl groups. The nonaqueous electrolyte may contain one kind of the trifluoropropionic acid ester (1), or may contain two or more kinds of the trifluoropropionic acid esters (1). Especially with 3,3,3-methyl trifluoropropionate (FMP) in which R1 is a methyl group, low viscosity and high oxidation resistance can be obtained. It is preferable therefore to use a trifluoropropionic acid ester (1) including at least FMP. The ratio of the FMP in the trifluoropropionic acid ester (1) is, for example, 50 mass % or more, preferably 80 mass % or more. Only FMP may be used.

In the formula (2), examples of the C₁₋₃ alkyl group and the C₁₋₃ alkyl group moiety in the fluorinated C₁₋₃ alkyl group represented by R2 and R3 each include those exemplified for R1. In the fluorinated C₁₋₃ alkyl group, the number of fluorine atoms is appropriately determined depending on the number of carbon atoms in the alkyl group, and is preferably 1 to 5, and may be 1 to 3. Examples of the fluorinated C₁₋₃ alkyl group include a fluoromethyl group, a fluoroethyl group, a difluoromethyl group, a trifluoromethyl group, and a 2,2,2-trifluoroethyl group. In particular, R2 is preferably a hydrogen atom or a C₁₋₃ alkyl group, and particularly preferably a hydrogen atom. R3 is preferably a C₁₋₃ alkyl group.

In the formula (2), it suffices when one or two of X1 to X4 are fluorine atoms. When one of X1 to X4 is a fluorine atom, the fluorine atom may be either at the α-position (e.g., X1) or at the β-position (e.g., X3) in the carbonyl group of the zonula (2). When two of X1 to X4 are fluorine atoms, the fluorine atom may be only at the α-position (X1 and X2), only at the β-position (X3 and X4), or at the α-position and the β-position (e.g., X1 and X3) in the carbonyl group of the formula (2). In particular, it is preferable that at least one of X1 and X2 is a fluorine atom (i.e., the α-position of the carbonyl group is a fluorine atom).

Examples of the fluorinated carboxylic acid ester (2) include ethyl 2-fluoropropionate (αF-EP), ethyl 3-fluoropropionate, ethyl 2,2-difluoropropionate, ethyl 2,3-difluoropropionate, and ethyl 3,3-difluoropropionate. In particular, a fluorinated carboxylic acid ester having a fluorine atom at the α-position is preferred, and the fluorinated carboxylic acid ester (2) preferably includes at least αF-EP.

In the formula (3), examples of the C₁₋₃ alkyl group represented by R4 and the C₁₋₃ alkyl group moiety in the fluorinated C₁₋₃ alkyl group represented by R5 each include those exemplified for R1. The number of fluorine atoms in R5 can be selected depending on the number of carbon atoms in the C₁₋₃ alkyl group, and is preferably 1 to 5, more preferably 1 to 3. R4 is preferably a methyl or ethyl group, and in view of lowering the viscosity, preferably a methyl group. R5 is preferably a trifluoromethyl group, a 2,2,2-trifluoroethyl group, and the like, and particularly preferably a 2,2,2-trifluoroethyl group that can be derived from 2,2,2-trifluoroethanol, which is easily available.

Among the carboxylic acid-fluoroalkyl esters (3), 2,2,2-trifluoroethyl acetate (FEA) is preferred. Therefore, it is preferable to use a carboxylic acid-fluoroalkyl ester (3) including at least FEA.

The trifluorocarboxylic acid ester (1) is considered to bring out the high durability performance of the SEI. The carboxylic acid-fluoroalkyl ester (3) has an effect of improving the film-forming ability by the fluorinated carboxylic acid ester (2), and can further suppress the decomposition of the trifluorocarboxylic acid ester (1). The carboxylic acid-fluoroalkyl ester (3) contains no fluorine in R4 and will not cause HF desorption by alkali, and is therefore considered to form a surface film with high durability.

The content ratio of the carboxylic acid ester (F) in the nonaqueous solvent is, for example, 10 vol % or more, may be 20 vol % or more, may be 30 vol % or more, and may be 35 vol % or more, or 40 vol % or more. The content ratio of the carboxylic acid ester (F) in the nonaqueous solvent is, for example, 80 vol % or less, may be 70 vol % or less, and may be 60 vol % or less. The range of the content ratio of the carboxylic acid ester (F) in the nonaqueous solvent may be, for example, 10 vol % to 80 vol %, may be 35 vol % to 80 vol %, and may be 40 vol % to 70 vol %.

Among the carboxylic acid esters (F), the trifluorocarboxylic acid ester (1) and the carboxylic acid-fluoroalkyl ester (3) are particularly preferred. The proportion of the total amount of the trifluorocarboxylic acid ester (1) and the carboxylic acid-fluoroalkyl ester (3) in the carboxylic acid ester (F) may be 50 vol % or more, may be 70 vol % or more, and may be 90 vol % or more.

As the carboxylic acid ester (F), it is particularly desirable to use at least one selected from the group consisting of methyl 3,3,3-trifluoropropionate and 2,2,2-trifluoroethyl acetate. Of the carboxylic acid ester (F), 50 vol % or more, or further 70 vol % or more or 90 vol % or more may be constituted of at least one selected from the group consisting of methyl 3,3,3-trifluoropropionate and 2,2,2-trifluoroethyl acetate.

The nonaqueous electrolyte can further contain an additive. However, the nonaqueous electrolyte recovered from the nonaqueous electrolyte secondary battery may contain almost no additive. In the latter case, an oxidation product or reduction product of the additive is contained as a film component at the positive electrode surface or the negative electrode surface. Even in such a case, since the additive remains at a level equal to or above the detection limit in the nonaqueous electrolyte collected from the nonaqueous electrolyte secondary battery, the presence of the additive in the nonaqueous electrolyte can be confined.

The nonaqueous electrolyte may contain, as an additive, an unsaturated carbonic acid ester. As the unsaturated carbonic acid ester, vinylene carbonate (VC), vinyl ethylene carbonate (VEC), divinyl ethylene carbonate (DVEC), and the like can be used.

The content ratio of the unsaturated carbonic acid ester in the nonaqueous electrolyte may be a concentration at or above the detection limit. The content ratio of the unsaturated carbonic acid ester in the nonaqueous electrolyte, for example, may be 0.01 mass % or more, may be 0.1 mass % or more, and may be 0.5 mass % or more. The content ratio of the unsaturated carbonic acid ester in the nonaqueous electrolyte is, for example, 3 mass % or less, may be 2 mass % or less, and may be 1 mass % or less.

The nonaqueous electrolyte may contain, as an additive, an acid anhydride. The acid anhydride is considered to have an effect of forming a surface film on the negative electrode, to improve the high-temperature cycle characteristics of the secondary battery. Although the acid anhydride may increase the internal resistance in some cases, when FEC and a carboxylic acid ester (F) are used in combination, by adding a small amount of an acid anhydride, the effect by the FEC and the carboxylic acid ester (F) of suppressing the increase in internal resistance can be enhanced. This is presumably because, when a crack occurs in the negative electrode active material during charge-discharge cycles, the acid anhydride reacts quickly with a new surface generated by the crack, to form a protective surface film having low resistance.

As die acid anhydride, it is desirable to use a cyclic acid anhydride having a simple structure, in view of effectively utilizing its constituent element in the formation of a protective surface film. Examples of such an acid anhydride include diglycolic anhydride, maleic anhydride, succinic anhydride, acetic anhydride, phthalic anhydride, and benzoic anhydride. The acid anhydride may be used singly or in combination of two or more kinds. In particular, glycolic anhydride, succinic anhydride, and the like are preferred.

The content ratio of the acid anhydride in the nonaqueous electrolyte may be a concentration equal to or higher than the detection limit. The content ratio of the acid anhydride in the nonaqueous electrolyte, for example, may be 0.01 mass % or more, may be 0.1 mass % or more, and may be 0.5 mass % or more. The content ratio of the acid anhydride in the nonaqueous electrolyte, for example, may be 3 mass % or less, may be 2 mass % or less, and may be 1 mass % or less. The content ratio of the acid anhydride in the nonaqueous electrolyte may be 0.01 mass % or more and 3 mass % or less, may be 0.1 mass % or more and 2 mass % or less, and may be 0.5 mass % or more and 1 mass % or less.

The content ratio of each component in the nonaqueous electrolyte can be determined by, for example, gas chromatography under the following conditions.
Instrument used: GC-2010 Plus, available from Shimadzu Corporation
Column: HP-1 (membrane thickness 1 μm, inner diameter 0.32 mm, length 60 m), available from J&W Corporation
Column temperature: increased from 50° C. to 90° C. at a temperature increase rate of 5° C./min and held at 90° C. for 15 minutes and then increased from 90° C. to 250° C. at a temperature increase rate of 10° C./min and held at 250° C. for 15 minutes
Split ratio: 1/50
Linear velocity: 30.0 cm/sec
Inlet temperature: 270° C.
Injection amount: 1 μL
Detector: FID 290° C. (sens. 10¹)

### (Nonaqueous Solvent)

The nonaqueous electrolyte may contain a nonaqueous solvent other than FEC and the carboxylic acid ester (F). As such a nonaqueous solvent, a cyclic carbonic acid ester, a chain carbonic acid ester, a cyclic carboxylic acid ester, a chain carboxylic acid ester, and the like can be used. Examples of the cyclic carbonic acid ester include propylene carbonate (PC), and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL), and γ-valerolactone (GVL). Examples of the chain carboxylic acid ester include methyl formate, ethyl formate, propyl formate, methyl acetate (MA), ethyl acetate, propyl acetate, methyl propionate, ethyl propionate, and propyl propionate. These nonaqueous solvents may be used singly or in combination of two or more kinds.

### (Salt)

In the case of a lithium-ion battery, a lithium salt can be used as the salt (electrolyte salt). Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borates, and imides. Examples of the borates include lithium difluorooxalate borate and lithium bisoxalate borate. Examples of the imides include lithium bisfluorosulfonyl imide (LiN(FSO₂)₂) and lithium bistrifluoromethanesulfonyl imide (LiN(CF₃SO₂)₂). The nonaqueous electrolyte may contain these electrolyte salts singly or in combination of two or more kinds. The concentration of the electrolyte salt in the nonaqueous electrolyte is, for example, 0.5 mol/L or more and 2 mol/L or less.

### [Separator]

It is desirable to interpose a separator between the positive electrode and the negative electrode. The separator is excellent in ion permeability and has moderate mechanical strength and electrically insulating properties. As the separator, a microporous thin film, a woven fabric, a nonwoven fabric, and the like can be used. As the material of the separator, a polyolefin, such as polypropylene and polyethylene, is preferred.

As an example of the structure of the secondary battery, a structure in which an electrode group formed by winding the positive electrode and the negative electrode with the separator interposed therebetween is housed in an outer body, together with the electrolyte solution, is exemplified. However, without limited thereto, an electrode group in a different form may be adopted. For example, the electrode group may be of a stacked type formed by stacking the positive electrode and the negative electrode with the separator interposed therebetween. The form of the nonaqueous electrolyte secondary battery is also not limited, and may of, for example, a cylindrical, prismatic, coin, button, or laminate type.

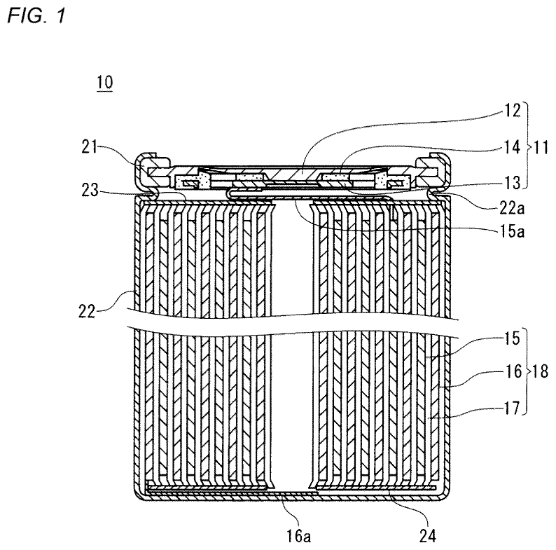

The structure of the nonaqueous electrolyte secondary battery will be described below with reference to FIG. 1. FIG. 1 is a longitudinal sectional view of a cylindrical secondary battery, which is one example of the present embodiment. The present disclosure, however, is not limited to the following configuration.

The nonaqueous electrolyte secondary battery (hereinafter, battery 10) includes an electrode group 18, a nonaqueous electrolyte (not shown), and a bottomed cylindrical battery can 22 housing them. A sealing assembly 11 is fixed by crimping at the opening of the battery can 22, with a gasket 21 interposed therebetween. This seals the inside of the battery. The sealing assembly 11 includes a valve body 12, a metal plate 13, and an annular insulating member 14 interposed between the valve body 12 and the metal plate 13. The valve body 12 and the metal plate 13 are connected to each other at their respective centers. A positive electrode lead 15a extended from the positive electrode plate 15 is connected to the metal plate 13. Therefore, the valve body 12 functions as a positive external terminal. A negative electrode lead 16a extended from the negative electrode plate 16 is connected to the bottom inner surface of the battery can 22. An annular groove 22a is formed near the open end of the battery can 22. A first insulating plate 23 is placed between one end face of the electrode group 18 and the annular groove 22a. A second insulating plate 24 is placed between the other end face of the electrode group 18 and the bottom of the battery can 22. The electrode group 18 is formed by winding the positive electrode plate 15 and the negative electrode plate 16 together, with the separator 17 interposed therebetween.

### (Supplementary Notes)

The above description discloses the following techniques.

### (Technique 1)

A nonaqueous electrolyte secondary battery, comprising
a positive electrode, a negative electrode, and a nonaqueous electrolyte, wherein
the negative electrode includes a silicon-containing carbon material,
the silicon-containing carbon material includes an amorphous carbon phase, and silicon phases dispersed in the amorphous carbon phase,
the nonaqueous electrolyte contains a nonaqueous solvent, and a salt dissolved in the nonaqueous solvent, and
the nonaqueous solvent contains fluoroethylene carbonate and a fluorine-containing carboxylic acid ester.

### (Technique 2)

The nonaqueous electrolyte secondary battery according to technique 1, wherein a content ratio of the silicon phases in the silicon-containing carbon material is 40 mass' or more or 50 mass % or more.

### (Technique 3)

The nonaqueous electrolyte secondary battery according to technique 1 or 2, wherein an average particle diameter of the silicon phases is less than 20 nm.

### (Technique 4)

The nonaqueous electrolyte secondary battery according to any one of techniques 1 to 3, wherein a content ratio of the fluoroethylene carbonate in the nonaqueous solvent is 5 vol % or more and 30 vol % or less.

### (Technique 5)

The nonaqueous electrolyte secondary battery according to any one of techniques 1 to 4, wherein a content ratio of the fluorine-containing carboxylic acid ester in the nonaqueous solvent is 10 vol % or more and 80 vol % or less.

### (Technique 6)

The nonaqueous electrolyte secondary battery according to any one of techniques 1 to 5, wherein a content ratio of the fluorine-containing carboxylic acid ester in the nonaqueous solvent is 35 vol % or more and 80 vol % or less.

### (Technique 7)

The nonaqueous electrolyte secondary battery according to any one of techniques 1 to 6, wherein the fluorine-containing carboxylic acid ester is at least one selected from the group consisting of methyl 3,3,3-trifluoropropionate and 2,2,2-trifluoroethyl acetate.

### (Technique 8)

The nonaqueous electrolyte secondary battery according to any one of techniques 1 to 7, wherein the nonaqueous electrolyte further contains a cyclic acid anhydride.

### (Technique 9)

The nonaqueous electrolyte secondary battery according to any one of techniques 1 to 8, wherein the positive electrode includes a lithium transition metal composite oxide containing at least nickel as a transition metal.

### (Technique 10)

The nonaqueous electrolyte secondary battery according to technique 9, wherein a ratio of Ni to total metals other than lithium contained in the lithium transition metal composite oxide is 80 atom % or more.

The present disclosure will be more specifically described below with reference to Examples and Comparative Examples. The present disclosure, however, is not limited to the following Examples.

### Example 1

A nonaqueous electrolyte secondary battery was fabricated and evaluated by die following procedure.

### (1) Production of Positive Electrode

LiNi_{0.91}Co_{0.04}Al_{0.05}O₂, which was a composite oxide HN, was used as a positive electrode active material. One hundred parts by mass of the composite oxide HN (average particle diameter 12 μm), 1 part by mass of carbon nanotubes, 1 part by mass of polyvinylidene fluoride, and an appropriate amount of NMP were mixed together, to obtain a positive electrode slurry. Next, the positive electrode slurry was applied onto both sides of an aluminum foil, the applied films were dried, and then rolled, to form a positive electrode mixture layer on each of both sides of the aluminum foil. A positive electrode was thus obtained.

### (2) Production of Negative Electrode

A silicon-containing carbon material (average particle diameter 5 μm) and graphite (average particle diameter 20 μm) were mixed in a mass ratio of 10:90, to obtain a negative electrode active material. The silicon-containing carbon material (Si/AmoC) was prepared in the following manner.

### [Preparation of Si/AmoC]

### <First Step>

Graphitizable carbon (soft carbon) was prepared as a carbon source.

### <Second Step>

The carbon source was mixed with raw material silicon (3N, average particle diameter 10 μm). In the mixture, the mass ratio of the carbon source to the raw material silicon was 40:60.

The mixture was packed in a pot (made of SUS, volume: 500 mL) of a planetary ball mill (P-5, available from Fritsch Co., Ltd.). Then, 24 SUS balls (diameter 20 mm) were put into the pot, and with the lid closed, the mixture was pulverized at 200 rpm for 50 hours in an inert atmosphere.

### <Third Step>

Next, the powdery mixture was taken out in an inert atmosphere, and baked at 800° C. for 4 hours, in an inert atmosphere, with a pressure applied by a hot press, into a sintered body of the mixture.

### <Fourth Step>

Next, the sintered body was crushed, and passed through a 40-μm mesh, to obtain Si/AmoC particles each constituted of an amorphous carbon phase and silicon particles dispersed in the amorphous carbon phase.

The silicon content in the Si/AmoC particles was 60 mass %, and the average particle diameter was 6 μm. The average particle diameter of the silicon phases was less than 20 nm.

A negative electrode slurry was prepared by mixing 98 parts by mass of the negative electrode active material, 1 part by mass of a sodium salt of CMC (CMC-Na), 1 part by mass of SBR, and an appropriate amount of water. Subsequently, the negative electrode slurry was applied onto both sides of a copper foil serving as a negative electrode current collector, and the applied films were dried, and then rolled, to form a negative electrode mixture layer on each of both sides of the copper foil. A negative electrode was thus obtained.

### (3) Preparation of Nonaqueous Electrolyte

A nonaqueous electrolyte was prepared by dissolving LiPF₆ at a concentration of 1.0 mol/L in a mixed solvent containing FEC and FMP (methyl 3,3,3-trifluoropropionate) in a volume ratio of 20:80. To the nonaqueous electrolyte, 2% by mass of vinylene carbonate (VC) was added.

### (4) Fabrication of Battery

One end of a positive electrode lead made of aluminum was attached to the positive electrode. One end of a negative electrode lead made of nickel was attached to the negative electrode. The positive electrode and the negative electrode were wound with a separator made of polyethylene interposed therebetween, to form an electrode group. The electrode group was vacuum-dried at 105° C. for 2 hours, and then, housed in a bottomed cylindrical battery case serving as a negative electrode terminal. The battery case used here was made of iron. Next, after the nonaqueous electrolyte was injected into the battery case, the opening of the battery case was closed with a sealing assembly made of metal serving as a positive electrode terminal. At this time, a gasket made of resin was interposed between the sealing assembly and the opening end of the battery case. The other end of the positive electrode lead was connected to the sealing assembly, and the other end of the negative electrode lead was connected to the inner bottom surface of the battery case. In this way, a 2170-type cylindrical battery A1 with a design capacity of 5 Ah was fabricated.

### Example 2

A battery A2 was fabricated in the same manner as in Example 1, except that, in the preparation of a nonaqueous electrolyte, instead of FMP, FEA (2,2,2-trifluoroethyl acetate) was used.

### Example 3

A battery A3 was fabricated in the same manner as in Example 1, except that 0.5% by mass of diglycolic anhydride (DGA) was added to the nonaqueous electrolyte.

### Example 4

A battery A4 was fabricated in the same manner as in Example 1, except that 0.5% by mass of succinic anhydride (SUCA) was added to the nonaqueous electrolyte.

### Example 5

A battery A5 was fabricated in the same manner as in Example 1, except that, in the preparation of a Si/AmoC, the ball-milling conditions were changed, to control the average particle diameter of the silicon phases to about 100 nm.

### Comparative Example 1

A battery B1 was fabricated in the same manner as in Example 1, except that in the preparation of a nonaqueous electrolyte, in place of the mixed solvent containing FEC and FMP in a volume ratio of 20:80, a mixed solvent containing EC and EMC in a volume ratio of 20:80 was used.

### Comparative Example 2

A battery B2 was fabricated in the same manner as in Comparative Example 1, except that, in place of the Si/AmoC, SiOₓ (x=0.9, average particle diameter 6 μm) was used.

### Comparative Example 3

A battery B3 was fabricated in the same manner as in Example 1, except that, in place of the Si/AmoC, SiOₓ (x=0.9, average particle diameter 6 μm) was used.

### (5) Evaluation

### <Initial DCIR>

In a 25° C. temperature environment, the battery was constant-current charged at a current of 0.2 It until the voltage reached 4.2 V, and then constant-voltage charged at a constant voltage of 4.2 V until the current reached 0.02 It. The battery was then allowed to rest for 20 minutes. In this way, a battery with SOC 100% was obtained. The obtained battery with SOC 100% was discharged at a constant current of 0.3 It until the state of charge (SOC) reached 10%. With respect to the battery with SOC 10%, discharging was performed for 10 seconds at current values of 0 A, 0.1 A, 0.5 A, and 1.0 A, and the voltage values at the end of each discharging were measured. The relationship between the current values at discharging and the voltage values after 10 seconds was approximated to a straight line by the least squares method. From the absolute value of the slope of the straight line, an initial DCIR was calculated.

### <Charge-Discharge Cycle>

The battery after measuring the initial DCIR was subjected to 100 charge-discharge cycles under the following conditions.

### <Charging>

In a 25° C. temperature environment, the battery was charged at a constant current of 0.2 It until the voltage reached 4.2 V. and then charged at a constant voltage of 4.2 V until the current reached 0.02 It. The battery after constant-voltage charging was allowed to rest for 20 minutes.

### <Discharging>

After allowed to rest, in a 25° C. environment, the battery was discharged at a constant current of 0.3 It until the voltage reached 2.5 V.

### <DCIR Increase Rate>

With respect to the battery after 100 cycles, a DCIR(100) was determined by the same procedure as the initial DCIR, and a DCIR increase rate was calculated from the following equation.

DCIR increase rate (%)=100×(DCIR(100)−initial DCIR)/initial DCIR

Evaluation results of each Example and each Comparative Example are shown in Table 1.

TABLE 1

| | | | Si- | | |
|---|---|---|---|---|---|
| | | Si | containing | | DCIR |
| | Si- | particle | material/ | | increase |
| | containing | diameter | graphite | | rate |
| | material | (nm) | (mass ratio) | nonaqueous electrolyte | (%) |
| B1 | Si/Amo-C | <20 | 10:90 | 1.0MLiPF₆/EC + EMC(20:80 vol) + VC(2%) | +115 |
| B2 | SiOₓ | <20 | 10:90 | 1.0MLiPF₆/EC + EMC(20:80 vol) + VC(2%) | +95 |
| B3 | SiOₓ | <20 | 10:90 | 1.0MLiPF₆/FEC + FMP(20:80 vol) + VC(2%) | 102 |
| A1 | Si/Amo-C | <20 | 10:90 | 1.0MLiPF₆/FEC + FMP(20:80 vol) + VC(2%) | +30 |
| A2 | Si/Amo-C | <20 | 10:90 | 1.0MLiPF₆/FEC + FEA(20:80 vol) + VC(2%) | +32 |
| A3 | Si/Amo-C | <20 | 10:90 | 1.0MLiPF₆/FEC + FMP(20:80 vol) + VC(2%) + | +22 |
| | | | | DGA(0.5%) | |
| A4 | Si/Amo-C | <20 | 10:90 | 1.0MLiPF₆/FEC + FMP(20:80 vol) + VC(2%) + | +28 |
| | | | | SUCA(0.5%) | |
| A5 | Si/Amo-C | 100 | 10:90 | 1.0MLiPF₆/FEC + FMP(20:80 vol) + VC(2%) | +66 |

From Table 1, it would be understood that FEC and a carboxylic acid ester (F) fail to act effectively in suppressing the increase of DCIR when SiOₓ is used, but they act effectively when a Si/AmoC is used. It would also be understood that the effect of suppressing the increase in DCIR is enhanced by adding a small amount of an acid anhydride to the nonaqueous electrolyte. Furthermore, it would be understood that the effect of suppressing the increase in DCIR is more noticeable when the average particle diameter of the silicon phases is smaller.

### INDUSTRIAL APPLICABILITY

The nonaqueous electrolyte secondary battery according to the present disclosure is suitably applicable as a main power source for mobile communication devices, portable electronic devices, etc., an in-vehicle power source, and the like, but the application thereof is not limited to them.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: secondary battery, 11: sealing assembly, 12: valve body, 13: metal plate, 14: insulating member, 15: positive electrode. 15a: positive electrode lead. 16: negative electrode, 16a: negative electrode lead, 17: separator, 18: electrode group, 21: gasket, 22: battery can. 22a: groove, 23: first insulating plate, 24: second insulating plate, 16: negative electrode

1. A nonaqueous electrolyte secondary battery, comprising
a positive electrode, a negative electrode, and a nonaqueous electrolyte, wherein
the negative electrode includes a silicon-containing carbon material,
the silicon-containing carbon material includes an amorphous carbon phase, and silicon phases dispersed in the amorphous carbon phase,
the nonaqueous electrolyte contains a nonaqueous solvent, and a salt dissolved in the nonaqueous solvent, and
the nonaqueous solvent contains fluoroethylene carbonate and a fluorine-containing carboxylic acid ester.

2. The nonaqueous electrolyte secondary battery according to claim 1, wherein a content ratio of the silicon phases in the silicon-containing carbon material is 40 mass % or more.

3. The nonaqueous electrolyte secondary battery according to claim 1, wherein a content ratio of the silicon phases in the silicon-containing carbon material is 50 mass % or more.

4. The nonaqueous electrolyte secondary battery according to claim 1, wherein an average particle diameter of the silicon phases is less than 20 nm.

5. The nonaqueous electrolyte secondary battery according to claim 1, wherein a content ratio of the fluoroethylene carbonate in the nonaqueous solvent is 5 vol % or more and 30 vol % or less.

6. The nonaqueous electrolyte secondary battery according to claim 1, wherein a content ratio of the fluorine-containing carboxylic acid ester in the nonaqueous solvent is 10 vol % or more and 80 vol % or less.

7. The nonaqueous electrolyte secondary battery according to claim 1, wherein a content ratio of the fluorine-containing carboxylic acid ester in the nonaqueous solvent is 35 vol % or more and 80 vol % or less.

8. The nonaqueous electrolyte secondary battery according to claim 1, wherein the fluorine-containing carboxylic acid ester is at least one selected from the group consisting of methyl 3,3,3-trifluoropropionate and 2,2,2-trifluoroethyl acetate.

9. The nonaqueous electrolyte secondary battery according to claim 1, wherein the nonaqueous electrolyte further contains a cyclic acid anhydride.

10. The nonaqueous electrolyte secondary battery according to claim 1, wherein the positive electrode includes a lithium transition metal composite oxide containing at least nickel as a transition metal.

11. The nonaqueous electrolyte secondary battery according to claim 10, wherein a ratio of Ni to total metals other than lithium contained in the lithium transition metal composite oxide is 80 atom % or more.
